(19) United States
(12) Patent Application Publication
(10) Pub. No.: US 2017/0163706 A1
(43) Pub. Date: Jun. 8, 2017

(54) Method, electronic device and system for controlling pull stream

(71) Applicants: Le Holdings (Beijing) Co., Ltd., Beijing (CN); LeCloud Computing Co., Ltd., Beijing (CN)

(72) Inventors: Fengyu Liu, Beijing (CN); Lizhi Wei, Beijing (CN); Feng Han, Beijing (CN); Zhengyu Lin, Beijing (CN)

(21) Appl. No.: 15/246,455

(22) Filed: Aug. 24, 2016

Related U.S. Application Data
(63) Continuation of application No. PCT/CN2016/088878, filed on Jul. 6, 2016.

(30) Foreign Application Priority Data
Dec. 7, 2015 (CN) 201510889329.2

(51) Int. Cl. H04L 29/06; H04L 29/08

(52) U.S. Cl. CPC H04L 65/602; H04L 67/20; H04L 65/4069

(57) ABSTRACT

Disclosed are a method, an electronic device and a system for controlling a pull stream. The method includes: receiving a user request forwarded by a content delivery network (CDN) server, wherein the user request is used for requesting to watch a live video; detecting whether a stream state of the live video at a source server is on live, wherein the stream state is a stream state of a live video of the user request; instructing the source server to pull a video stream of the live video to a third-party server if the stream state at the source server is not on live; receiving a stream state returned by the source server, wherein the stream state returned by the source server is on live; and sending a back-to-source path of the video stream to the CDN server so that the CDN server sends the back-to-source path to a client.

### CROSS REFERENCE TO RELATED APPLICATIONS

This application is a continuation of International Application No. PCT/CN2016/088878, filed on Jul. 6, 2016, which is based upon and claims priority to Chinese Patent Application No. 201510889329.2, filed on Dec. 7, 2015, the entire contents of all of which are incorporated herein by reference.

### TECHNICAL FIELD

The present disclosure relates to telecommunications technologies, and more particularly, to a method, an electronic device and a system for controlling a pull stream.

### BACKGROUND

With the rapid development of Internet technologies, more and more information such as movie and television and music or the like gradually takes a network as a propagation medium. Stream media refers to a media form that uses a stream mode to transmit audio, video and multimedia files among networks. Compared with a webcasting form of watching after downloading, a typical characteristic of stream media is to compress continuous audio and video information and then upload the compressed audio and video information onto a network server so that a user can download and watch simultaneously without waiting until a whole file is completely downloaded. Due to the superiority of a streaming media technology for a stream media server, the technology is widely used in video on demand, video conference, remote education, telemedicine and online live broadcast systems.

A live video file provider pushes streaming media files to source servers through a stream pushing technology. When watching a live video file, a watcher sends out a watch request, and a live video file stream is pulled to a client of the watcher through a stream pulling technology.

The stream pulling technology refers to a technology through which the live video file stream pushed by the live video file provider is pulled to the client of the watcher. In a stream pulling process, the stream may likely go through a plurality of servers. In the prior art, if a live video stream requested by a watcher to watch is not in a source server, the watcher cannot watch the live video even though the live video stream is in other third-party servers.

### SUMMARY

The present disclosure provides a method, an electronic device and a system for controlling a pull stream, which can solve a problem that a watcher cannot watch a live video pushed to a third-party server.

To solve the foregoing technical problem, in a first aspect, embodiments of the present disclosure provide a method for controlling a pull stream, implemented by a server, including:

receiving a user request forwarded by a content delivery network (CDN) server, where the user request is used for requesting to watch a live video;

detecting whether a stream state of the live video at a source server is on live, where the stream state is a stream state of a live video of the user request;

instructing the source server to pull a video stream of the live video to a third-party server if the stream state at the source server is not on live;

receiving a stream state returned by the source server, where the stream state returned by the source server is on live; and

sending a back-to-source path of the video stream to the CDN server so that the CDN server sends the back-to-source path to a client.

In a second aspect, embodiments of the present disclosure provide a non-transitory computer-readable storage medium storing executable instructions, wherein the executable instructions are configured to perform any methods for controlling a pull stream mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for controlling a pull stream mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 illustrates a flowchart of a method for controlling a pull stream in accordance with some embodiments;

FIG. 2 illustrates a flowchart of another method for controlling a pull stream in accordance with some embodiments;

FIG. 3 illustrates a composition block diagram of an apparatus for controlling a pull stream in accordance with some embodiments;

FIG. 4 illustrates a composition block diagram of another apparatus for controlling a pull stream in accordance with some embodiments;

FIG. 5 illustrates a block diagram of a system for controlling a pull stream in accordance with some embodiments;

FIG. 6 illustrates a schematic structural diagram of an apparatus for controlling a pull stream in accordance with some embodiments; and

FIG. 7 is a block diagram of an electronic device which is configured to perform the methods for controlling a pull stream in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

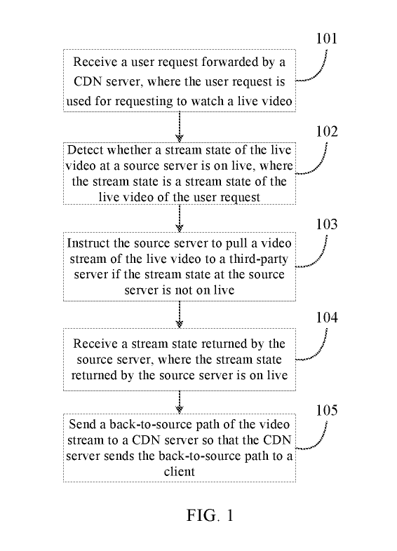

To solve the problem that a watcher cannot watch a live video pushed to a third-party server, embodiments of the present disclosure provide a method for controlling a pull stream, as shown in FIG. 1, the method includes following steps.

101: A user request forwarded by a CDN server is received, where the user request is used for requesting to watch a live video.

A CDN (Content Delivery Network) is a distributed content delivery network constructed on a data network. The CDN plays a role in overcoming disadvantages of insufficiency of an output bandwidth and a concurrent capacity of a single machine system by using stream media server cluster technologies, the quantity of concurrent streams supported by the system can be greatly improved, and adverse effects caused by single point of failure can be reduced or avoided.

A user's access is directed at a stream media server that is the nearest to the user and is in working order by utilizing a Global Server Load Balancing technology, so that the stream media server directly responds to the user's request. If a server has no content to be accessed by the user, the corresponding content may be automatically acquired from a source server according to configuration and provided for the user.

A user request is sent out by a client, including information of a live video requested to be watched. The client sends out a user request, which is received by a CDN server nearest to the user and in working order and forwarded to a control center.

102: It is detected whether a stream state of the live video at a source server is on live, where the stream state is a stream state of the live video of the user request.

Stream media is a form of media being transmitted and being played simultaneously. The stream state is a stream state of the live video of the user request. It is detected whether a stream state of the live video at a source server is on live, namely, it is detected whether a stream state of the live video of the user request is on live. If the stream state of the live video is on live, the live video can be played in a media form of stream media.

The source server provides a streaming media file. If a provider of stream media pushes a streaming media file to the stream media and the push of stream is not completed, the streaming media file corresponding to the source server is on live. Detection of a stream state is completed at the source server.

103: The source server is instructed to pull a video stream of the live video to a third-party server if the stream state at the source server is not on live.

The source server is instructed to pull the video stream of the live video to the third-party server if the stream state at the source server is not on live. After receiving a stream pulling instruction, the source server searches for a video stream of the user request from the third-party server, and pulls the video stream into the source server after the video stream of the user request is searched out.

104: A stream state returned by the source server is received, where the stream state returned by the source server is on live.

If the source server pulls the video stream of the user request, the stream state of the video stream is on live, and the source server sends the stream state of the video stream to the control center. If the source server fails to pull the video stream of the user request, the stream state of the video stays unchanged, and thus the source server does not resend the stream state of the video stream. The control center receives the stream state returned by the source server. The video stream of the video is present in the source server if the stream state of the source server is on live.

105: A back-to-source path of the video stream is sent to a CDN server so that the CDN server sends the back-to-source path to a client.

The back-to-source path of the video stream is sent to the CDN server if the stream state of the video stream is on live so that the CDN server sends the back-to-source path to the client. In this way, the client can implement transmitting and playing a live video simultaneously.

According to a method for controlling a pull stream provided by embodiments of the present disclosure, a user request forwarded by a CDN server is received, it is detected whether a stream state of a live video requested to be watched at a source server is on live, the source server is instructed to pull a video stream of the live video to a third-party server if the stream state at the source server is not on live. When the source server successfully pulls the video stream of the live video from a third party, a stream state returned by the source server is received, and a back-to-source path of a live video stream is sent to the CDN server so that the CDN server sends the back-to-source path to a client. Compared with the prior art, in embodiments of the present disclosure, a stream is not pulled unless a user request forwarded by a CDN server is received, thereby avoiding waste of server resources by an invalid pull stream. In the present disclosure, a source server can be instructed to pull a live video stream to a third-party server, and the live video stream of the third-party server is pulled into the source server. In this way, a watcher can watch a live video pushed to the third-party server.

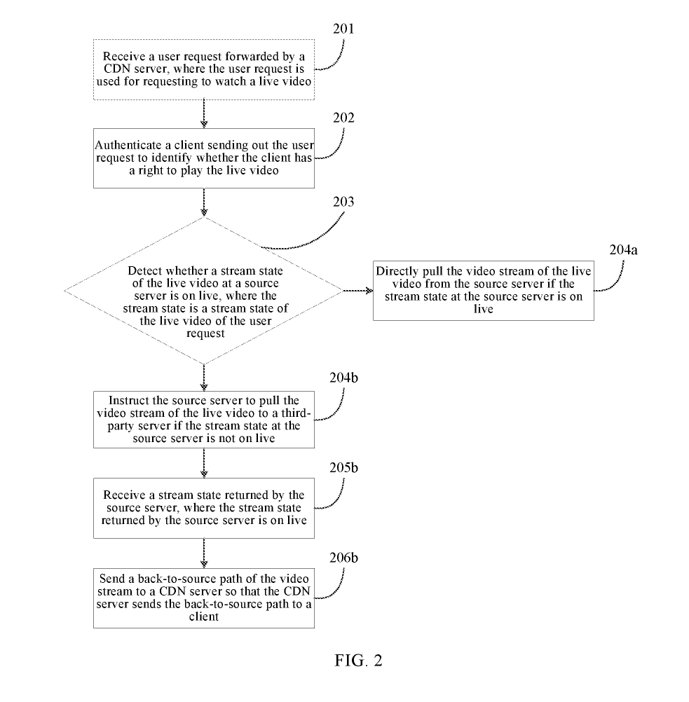

Further, as refinement and expansion of FIG. 1, embodiments of the present disclosure provide another method for controlling a pull stream, as shown in FIG. 2, the method includes following steps.

201: A user request forwarded by a CDN server is received, where the user request is used for requesting to watch a live video.

The received user request includes time information on sending out a request, user information, live video information and a request for playing the live video. The received user request is forwarded by the CDN server. The CDN server does not provide the video stream of the live video for a client.

202: A client sending out the user request is authenticated to identify whether the client has a right to play the live video.

The user request includes user account information, and different account numbers have different rights. Video resources that can be watched are different if rights are different. A client sending out the user request is authenticated, namely it is identified whether the client has a right to play the live video. Information of no right to watch is returned to the client if the client has no right to watch a video of a user request sent by the client. Further detection is carried out if the client has a right to watch a video of a user request sent by the client.

203: It is detected whether a stream state of the live video at a source server is on live, where the stream state is a stream state of the live video of the user request.

The source server stores videos pushed by a stream media provider, and sends information on a live video stream provided by the stream media provider to the control center. The stream state of the live video detected in the control center is the stream state of the live video at the source server.

204a: The video stream of the live video is directly pulled from the source server if the stream state at the source server is on live.

If it is detected that the stream state at the source server is on live and the source server stores the video stream of the live video, the video stream of the live video is directly pulled from the source server, in this way, pulling a video stream can be completed.

204b: The source server is instructed to pull the video stream of the live video to a third-party server if the stream state at the source server is not on live.

The live video of the user request has a stream address, through which the source server directly pulls the video stream of the live video from the third-party server.

The source server is instructed to pull the video stream of the live video to the third-party server, which needs to restrain the source server from pulling a frequency of the video stream to the third-party server. A fixed time interval is set for a stream pulling operation for the source server so that on one hand an identical live video request of user requests nearer in time is met by pulling a stream once to save server resources, and on the other hand excessive frequent user requests may cause a malicious attack on the server, thus a malicious attack on the server by frequent user requests can be prevented by restraining a frequency of pulling streams and reducing number of times of pulling streams.

205b: A stream state returned by the source server is received, where the stream state returned by the source server is on live.

After the source server pulls the live video stream, the stream state of the live video is changed. The stream state of the live video is received, and the stream state of the live video is returned by the source server.

206b: A back-to-source path of the video stream is sent to a CDN server so that the CDN server sends the back-to-source path to a client.

If the stream state of the video stream is on live, a back-to-source path of the video stream is sent to a CDN server so that the CDN server sends the back-to-source path to a client. In this way the client can implement transmitting and playing a live video simultaneously.

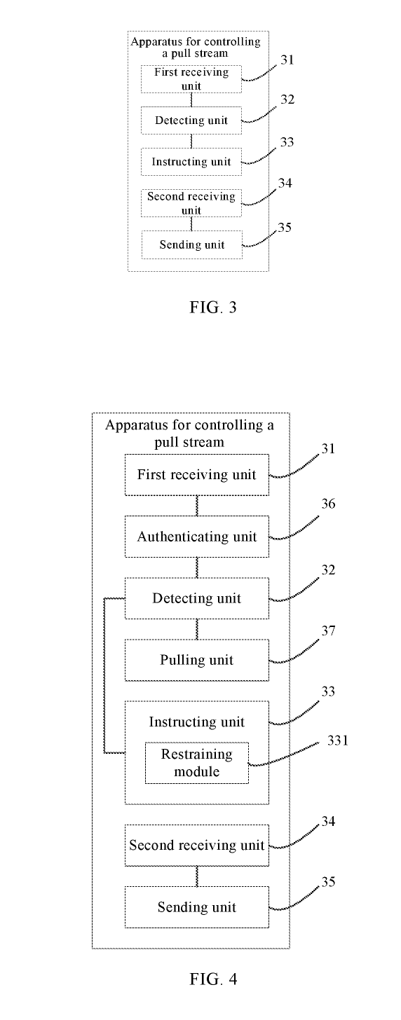

Further, as an implementation of the method as shown in FIG. 1 and FIG. 2, another embodiment of the present disclosure further provides an apparatus for controlling a pull stream. The apparatus embodiment corresponds to the preceding method embodiment and can implement all contents in the preceding method embodiment. For ease of reading, the apparatus embodiment merely makes a summary description of contents in the preceding method embodiment instead of detailed description of the contents in the method embodiment. As shown in FIG. 3, the apparatus includes: a first receiving unit 31, a detecting unit 32, an instructing unit 33, a second receiving unit 34 and a sending unit 35.

The first receiving unit 31 is configured to receive a user request forwarded by a content delivery network (CDN) server, where the user request is used for requesting to watch a live video.

The detecting unit 32 is configured to detect whether a stream state of the live video, of the user request received by the first receiving unit 31, at a source server is on live, where the stream state is a stream state of the live video of the user request.

The instructing unit 33 is configured to instruct the source server to pull a video stream of the live video to a third-party server if the stream state at the source server detected by the detecting unit 32 is not on live.

The second receiving unit 34 is configured to receive a stream state returned by the source server, where the stream state returned by the source server is on live.

The sending unit 35 is configured to send a back-to-source path of the video stream to the CDN server if the stream state received by the second receiving unit 34 is on live so that the CDN server sends the back-to-source path to a client.

Further, as shown in FIG. 4, the apparatus further includes:

an authenticating unit 36, configured to authenticate a client sending out the user request received by the first receiving unit 31 to identify whether the client has a right to play the live video.

Further, as shown in FIG. 4, the apparatus further includes:

a pulling unit 37, configured to directly pull the video stream of the live video from the source server if the stream state at the source server is on live after the detecting unit 32 detects whether the stream state at the source server is on live.

Further, the instructing unit 33 includes:

a restraining module 331, configured to restrain the source server from pulling a frequency of the video stream to the third-party server.

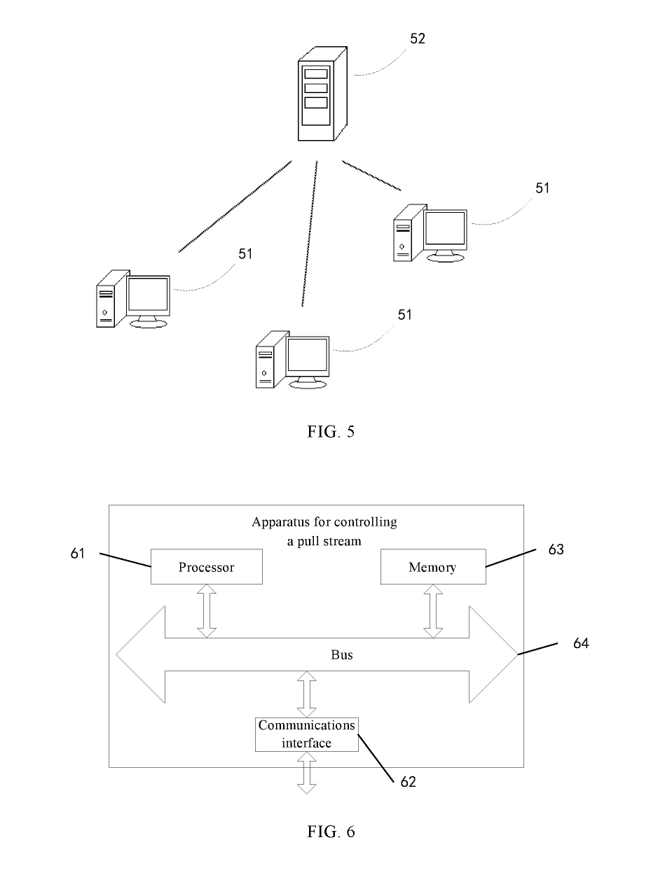

Further, as an implementation of the method as shown in FIG. 1 and FIG. 2, an embodiment of the present disclosure further provides a system for controlling a pull stream. This system embodiment corresponds to the preceding method embodiment and can implement all contents in the preceding method embodiment. For ease of reading, this system embodiment merely makes a summary description of contents in the preceding method embodiment instead of detailed description of the contents in the method embodiment. As shown in FIG. 5, the system includes a client 51, a content delivery network (CDN) server 52, a control center 53 and a source server 54.

Specifically, the client 51 is configured to send a user request;

the CDN server 52 is configured to forward the user request sent by the client 51, receive a back-to-source path and send the back-to-source path to the client;

the control center 53 is configured to detect whether a stream state of the live video of the user request sent by the CDN server 52 at the source server is on live, instruct the source server to pull a video stream of the live video of the user request to a third-party server if the stream state is not on live, receive a stream state returned by the source server, and send a back-to-source path of the video stream to the CDN server 52; and

the source server 54 is configured to pull the video stream of the live video to the third-party server and send the stream state of the live video to the control center 53.

According to an apparatus and a system for controlling a pull stream provided by embodiments of the present disclosure, a user request forwarded by a CDN server is received, it is detected whether a stream state of a live video requested to be watched at a source server is on live, the source server is instructed to pull a video stream of the live video to a third-party server if the stream state at the source server is not on live. When the source server successfully pulls the video stream of the live video from a third party, a stream state returned by the source server is received, and a back-to-source path of a live video stream is sent to the CDN server so that the CDN server sends the back-to-source path to a client. Compared with the prior art, in embodiments of the present disclosure, a stream is not pulled unless a user request forwarded by a CDN server is received, thereby avoiding waste of server resources by an invalid pull stream. In the present disclosure, a source server can be instructed to pull a live video stream to a third-party server, and the live video stream of the third-party server is pulled into the source server. In this way, a watcher can watch a live video pushed to the third-party server.

It is to be noted that in allusion to the foregoing apparatus for controlling a pull stream, functions of each unit module used in the embodiments of the present disclosure can be implemented through a hardware processor.

Exemplarily, as shown in FIG. 6, which illustrates a schematic structural diagram of an apparatus for controlling a pull stream according to embodiments of the present disclosure, the apparatus for controlling a pull stream can include: a processor 61, a communications interface 62, a memory 63 and a bus 64, where the processor 61, the communications interface 62 and the memory 63 complete communications among each other through the bus 64. The communications interface 62 can be configured to implement information transmission between the server and the client. The processor 61 can invoke a logic instruction in the memory 63 to execute the following method: a user request forwarded by a CDN server is received, where the user request is used for requesting to watch a live video; it is detected whether a stream state of the live video at a source server is on live, where the stream state is a stream state of the live video of the user request; the source server is instructed to pull a video stream of the live video to a third-party server if the stream state at the source server is not on live; a stream state returned by the source server is received, where the stream state returned by the source server is on live; and a back-to-source path of the video stream is sent to the CDN server so that the CDN server sends the back-to-source path to a client.

In addition, when a logic instruction in the foregoing memory 63 can be implemented in the form of a software functional unit and is sold or used as an independent product, the logic instruction can be stored in a computer-readable storage medium. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for controlling a pull stream mentioned by embodiments of the present disclosure.

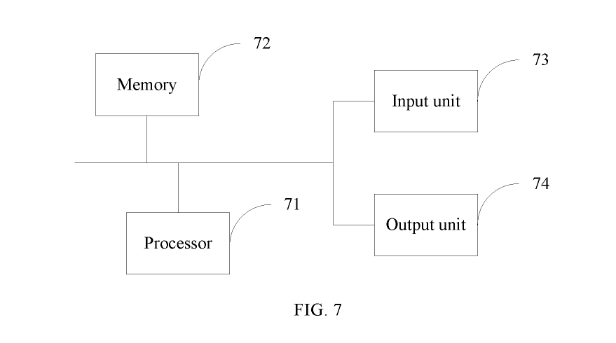

FIG. 7 is a block diagram of an electronic device which is configured to perform the methods for controlling a pull stream according to an embodiment of the present disclosure. As shown in FIG. 7, the device includes:

one or more processors 71 and memory 72. A processor 71 is showed in FIG. 7 for an example.

Device which is configured to perform the methods for controlling a pull stream can also include: input unit 73 and output unit 74.

Processor 71, memory 72, input unit 73 and output unit 74 can be connected by BUS or other methods, and BUS connecting is showed in FIG. 7 for an example.

Memory 72 can be used for storing non-transitory software program, non-transitory computer executable program and modules as a non-transitory computer-readable storage medium, such as corresponding program instructions/modules for the methods for controlling a pull stream mentioned by embodiments of the present disclosure (such as shown in FIG. 3, first receiving unit 31, detecting unit 32, instructing unit 33, second receiving unit 34 and sending unit 35). Processor 71 performs kinds of functions and controlling a pull stream of the electronic device by executing non-transitory software program, instructions and modules which are stored in memory 72, thereby realizes the methods for controlling a pull stream mentioned by embodiments of the present disclosure.

Memory 72 can include program storage area and data storage area, thereby the operating system and applications required by at least one function can be stored in program storage area and data created by using the device for controlling a pull stream can be stored in data storage area. Furthermore, memory 72 can include high speed Random-access memory (RAM) or non-volatile memory such as magnetic disk storage device, flash memory device or other non-volatile solid state storage devices. In some embodiments, memory 72 can include long-distance setup memories relative to processor 71, which can communicate with the device for controlling a pull stream by networks. The examples of said networks are including but not limited to Internet, Intranet, LAN, mobile Internet and their combinations.

Input unit 73 can be used to receive inputted number, character information and key signals causing user configures and function controls of the device for controlling a pull stream. Output unit 74 can include a display screen or a display device.

The said module or modules are stored in memory 72 and perform the methods for controlling a pull stream when executed by one or more processors 71.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for controlling a pull stream, implemented by a server, comprising:
receiving a user request forwarded by a content delivery network (CDN) server, wherein the user request is used for requesting to watch a live video;
detecting whether a stream state of the live video at a source server is on live, wherein the stream state is a stream state of a live video of the user request;
instructing the source server to pull a video stream of the live video to a third-party server if the stream state at the source server is not on live;
receiving a stream state returned by the source server, wherein the stream state returned by the source server is on live; and
sending a back-to-source path of the video stream to the CDN server so that the CDN server sends the back-to-source path to a client.

2. The method according to claim 1, further comprising:
authenticating a client sending out the user request to identify whether the client has a right to play the live video.

3. The method according to claim 1, wherein after the detecting whether a stream state at a source server is on live, the method further comprises:
directly pulling the video stream of the live video from the source server if the stream state at the source server is on live.

4. The method according to claim 1, wherein the instructing the source server to pull a video stream of the live video to a third-party server comprises:
restraining the source server from pulling a frequency of the video stream to the third-party server.

5. A non-transitory computer-readable storage medium storing executable instructions, wherein the executable instructions are configured to:
receive a user request forwarded by a CDN server, wherein the user request is used for requesting to watch a live video;
detect whether a stream state of the live video at a source server is on live, wherein the stream state is a stream state of a live video of the user request;
instruct the source server to pull a video stream of the live video to a third-party server if the stream state at the source server is not on live;
receive a stream state returned by the source server, wherein the stream state returned by the source server is on live; and
send a back-to-source path of the video stream to the CDN server so that the CDN server sends the back-to-source path to a client.

6. The non-transitory computer-readable storage medium according to claim 5, wherein the executable instructions are further configured to:
authenticate a client sending out the user request to identify whether the client has a right to play the live video.

7. The non-transitory computer-readable storage medium according to claim 5, wherein after the detecting whether a stream state at a source server is on live, the executable instructions are further configured to:
directly pull the video stream of the live video from the source server if the stream state at the source server is on live.

8. The non-transitory computer-readable storage medium according to claim 5, wherein the instructing the source server to pull a video stream of the live video to a third-party server comprises:
restraining the source server from pulling a frequency of the video stream to the third-party server.

9. An electronic device, comprising:
at least one processor; and
a memory communicably connected with the at least one processor for storing instructions executable by the at least one processor, wherein execution of the instructions by the at least one processor causes the at least one processor to:
receive a user request forwarded by a CDN server, wherein the user request is used for requesting to watch a live video;
detect whether a stream state of the live video at a source server is on live, wherein the stream state is a stream state of a live video of the user request;
instruct the source server to pull a video stream of the live video to a third-party server if the stream state at the source server is not on live;
receive a stream state returned by the source server, wherein the stream state returned by the source server is on live; and
send a back-to-source path of the video stream to the CDN server so that the CDN server sends the back-to-source path to a client.

10. The electronic device according to claim 9, wherein the instructions are executed to cause the at least one processor to:
authenticate a client sending out the user request to identify whether the client has a right to play the live video.

11. The electronic device according to claim 9, wherein after the detecting whether a stream state at a source server is on live, the instructions are executed to cause the at least one processor to:
directly pull the video stream of the live video from the source server if the stream state at the source server is on live.

12. The electronic device according to claim 9, wherein the instructing the source server to pull a video stream of the live video to a third-party server comprises:
restraining the source server from pulling a frequency of the video stream to the third-party server.
